(19) United States
(12) Patent Application Publication
(10) Pub. No.: US 2025/0064184 A1
(43) Pub. Date: Feb. 27, 2025

(54) FORCE DEFELCTING ELECTRONICS ENCLOSURE DEVICE

(71) Applicant: Mozart Malafaia, Lake Mary, FL (US)

(72) Inventor: Mozart Malafaia, Lake Mary, FL (US)

(21) Appl. No.: 18/941,203

(22) Filed: Nov. 8, 2024

Related U.S. Application Data
(63) Continuation-in-part of application No. 18/507,698, filed on Nov. 13, 2023.
(60) Provisional application No. 63/597,877, filed on Nov. 10, 2023.
(60) Provisional application No. 63/429,872, filed on Dec. 2, 2022.

(51) Int. Cl. A45C 11/00; H04B 1/3888

(52) U.S. Cl. CPC A45C 11/00; H04B 1/3888; A45C 2011/002

(57) ABSTRACT

A force deflecting case for a portable electronic device includes a front housing that is sized to receive a portable electronic device, plurality of side walls extend outward from the back surface along the sides of the device, and a central opening into which the display screen or other functional component of the device is positioned. A rear housing is positioned opposite to the front housing and includes a recessed front wall, and a plurality of side walls that extend upward along the sides of the device. Each of the front and rear housings include a plurality of bumper connectors that are aligned to engage a plurality of removable bumpers. Each of the bumpers deflect impacts and secure the housings together about the portable device. The front and rear housings include air gaps to permit the housings to individually flex upon receiving an impact.

### CROSS-REFERENCE TO RELATED APPLICATIONS

This application claims the benefit of U.S. Application Ser. No. 63/597,877 filed on Nov. 10, 2023, and is a continuation in part to U.S. application Ser. No. 18/507,698 filed on Nov. 13, 2023, the contents of each of which are incorporated herein by reference.

### TECHNICAL FIELD

The present invention relates generally to smartphone protective cases, and more particularly to a protective case for a portable electronic device that includes functionality for both absorbing and deflecting impactive forces with foreign objects.

### BACKGROUND

The statements in this section merely provide background information related to the present disclosure and may not constitute prior art.

The history of protective cases for portable electronic devices dates back to the early days of cell phones. Because early cell phones were bulky and expensive, cases were mostly constructed from leather or hard plastic and were designed to protect the phones from scratches and dents. In recent years, rigid and semi-rigid plastic and silicon blended cases have become popular. These cases are shaped and designed to securely engage a smartphone or other such device along the back surface and all four sides, and to directly absorb as much impactive force before transferring the force onto the device.

Unfortunately, even with advances in materials technology, it is not uncommon for devices to become cracked or damaged after relatively small impacts such as being dropped, even when using a protective case. This is because the way cases absorb impacts and transfer the forces onto the device has not changed.

The present invention, directed to a force deflecting electronics enclosure device differs from the conventional art in a number of aspects. The manner by which will become more apparent in the description which follows, particularly when read in conjunction with the accompanying drawings.

### SUMMARY OF THE INVENTION

The present invention is directed to a force deflecting case for a portable electronic device. One embodiment of the present invention can include a front housing having a shape and a size that is complementary to the shape and size of a portable electronic device such as a smartphone, a plurality of side walls that extend outward from the back surface along the sides of the portable device, and a central opening into which the display screen of the portable device can be positioned. The front housing includes a central opening into which the display screen of the device is positioned, and a plurality of side walls that extend outward from the back surface along the sides of the device. A rear housing is also provided having a recessed front wall for receiving the back surface of the portable electronic device, and a plurality of side walls that extend upward along the sides of the device.

Each of the front and rear housings include a plurality of bumper connectors that are aligned to form a plurality of unitary receptacles for engaging a plurality of bumpers. Each of the bumpers are constructed from a malleable and impact absorbing material, and function to both secure the front and rear housings together about the device, and to deflect and absorb impacts.

The front housing and the rear housing are constructed from materials that allow the components to individually flex upon receiving an impact. Additionally, the front and rear housings are sized specifically to receive a particular portable electronic device and to include an air gap into which the housings can flex.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1A is a front view of the front housing of the protective case, in accordance with one embodiment of the invention.

FIG. 1B is a back view of the front housing of the protective case, in accordance with one embodiment of the invention.

FIG. 2 is a perspective view of the rear housing of the protective case, in accordance with one embodiment of the invention.

FIG. 3 is a perspective view of the rear housing of the protective case in operation, in accordance with one embodiment of the invention.

FIG. 4 is a perspective view of the protective case in operation, in accordance with one embodiment of the invention.

FIG. 5A is a side view of the protective case in operation, in accordance with one embodiment of the invention.

FIG. 5B is a partial cutout view of the protective case in operation, in accordance with one embodiment of the invention.

FIG. 6 is a rear view of the protective case, in accordance with one embodiment of the invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

### Definitions

As described herein, a “unit” means a series of identified physical components which are linked together and/or function together to perform a specified function.

As described throughout this document, the term “about” “approximately” “substantially” and “generally” shall be used interchangeably to describe a feature, shape, or measurement of a component within a tolerance such as, for example, manufacturing tolerances, measurement tolerances or the like.

As described herein, the term “removably secured,” and derivatives thereof shall be used to describe a situation wherein two or more objects are joined together in a non-permanent manner so as to allow the same objects to be repeatedly joined and separated.

As described throughout this document, the term “complementary shape,” and “complementary dimension,” shall be used to describe a shape and size of a component that is identical to, or substantially identical to the shape and size of another identified component within a tolerance such as, for example, manufacturing tolerances, measurement tolerances or the like.

As described herein, the term “connector” includes any number of different elements that work alone or together to repeatedly join two items together in a nonpermanent manner. Several nonlimiting examples of connectors include, but are not limited to thread-to-connect, twist-to-connect, and push-to-connect type devices, opposing strips of hook and loop material (e.g., Velcro®), attractively oriented magnetic elements or magnetic and metallic elements, and compression fittings such as buckles, latches, snaps and buttons, for example. Each illustrated connector and complementary connector can be permanently secured to the illustrated portion of the device via manufacturing processes or via a permanent sealer such as glue, for example.

As described herein, the term “resilient qualities” and “shape memory” are used interchangeably to define the ability of a component to maintain a particular shape and to attempt to return to the particular shape after being bent, folded, twisted, or otherwise manipulated.

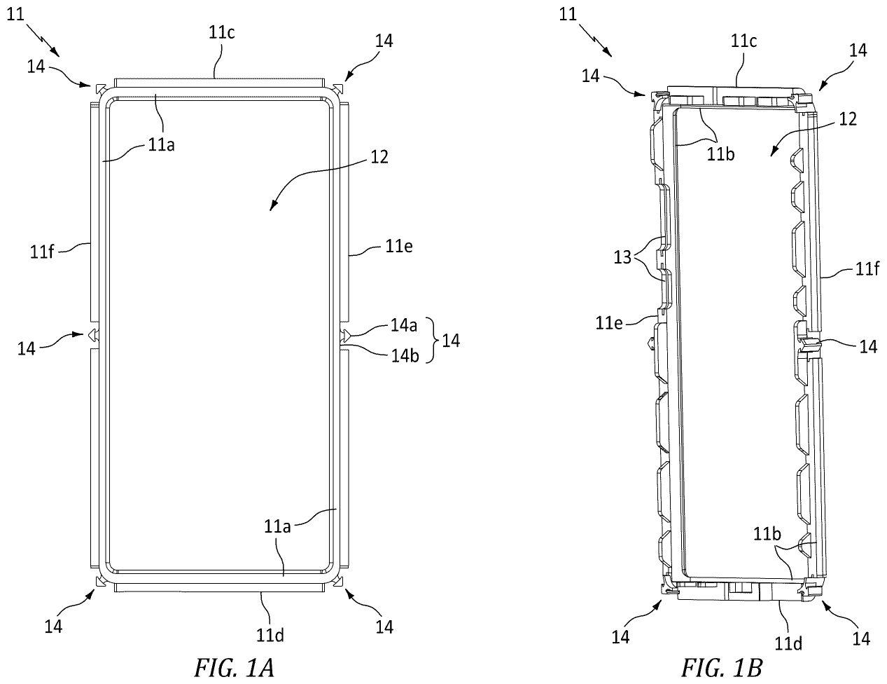

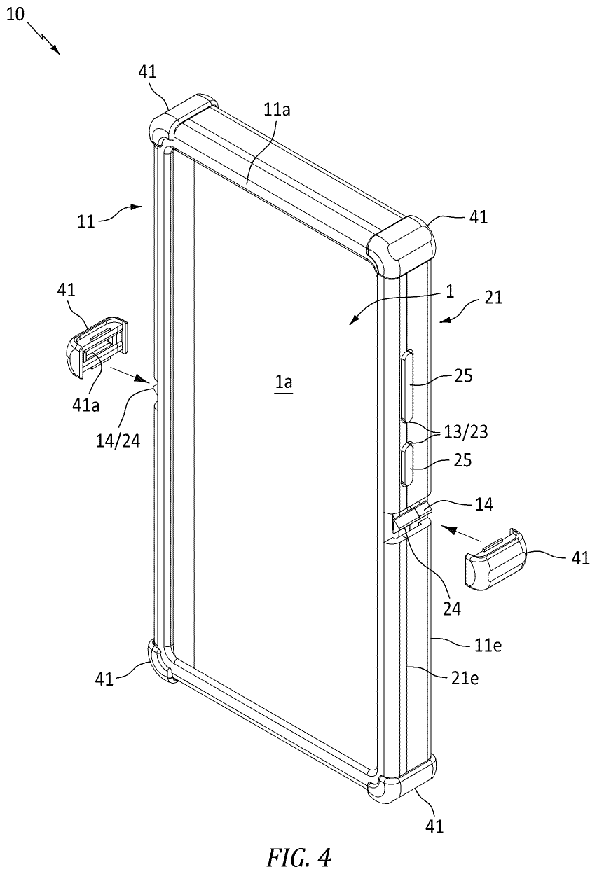

FIGS. 1A-6 illustrate one embodiment of a force deflecting electronics enclosure device 10 that are useful for understanding the inventive concepts disclosed herein. In each of the drawings, identical reference numerals are used for like elements of the invention or elements of like function. For the sake of clarity, only those reference numerals are shown in the individual figures which are necessary for the description of the respective figure. For purposes of this description, the terms “upper,” “bottom,” “right,” “left,” “front,” “vertical,” “horizontal,” and derivatives thereof shall relate to the invention as oriented in FIG. 4.

As shown in the drawings, the protective device can include, essentially, a front housing 11, a rear housing 21 and a plurality of removable bumpers 41. The case is designed to receive and store particular portable electronic device in a manner that provides an air gap into which the case body will flex upon being impacted with a foreign object. Such a feature reducing or eliminating a transfer of impactive forces onto the electronic device. Although described or illustrated for use with a smartphone, this is for illustrative purposes only, as the inventive case may be shaped and sized for use with any type of portable electronic device for which impact protection is sought.

FIGS. 1A and 1B illustrate one embodiment of a front housing 11 of the enclosure device 10. As shown, the front housing can include a generally rectangular-shaped member having a front surface 11a, a back surface 11b, a top wall 11c, a bottom wall 11d and a pair of side walls 11e and 11f. As shown, the rear surface 11b can be recessed relative to the walls 11c-11f, and thus forms a continuous lip that borders a large central opening 12.

As noted above, each enclosure device 10 will be manufactured for use with a specific portable electronic device having known dimensions, such as the smartphone illustrated in the drawings. As such, the walls of the front housing 11 will include a shape that is complementary to the outside shape of the specific device, such as a smartphone 1, and a size that is complementary to or slightly larger (e.g.,.1 mm-3 mm) than the device. Likewise, the lip formed by the back surface 11b will engage the top edges of the device, and the central opening 12 will include a shape and a size that is complementary to the shape and the size of the screen of the device.

In one embodiment, a plurality of openings and/or notches 13 can be provided along one or more of the walls 11c-11f of the front housing. Each of the notches can include a shape and size that is complementary to the shape and size of smartphone user interface component such as various buttons, charging ports, speakers, microphones, or other such items.

In one embodiment, a plurality of upper bumper connectors 14 can be positioned along each of the walls 11c-11f. Each of the upper bumper connectors 14 can include a generally arrow shaped protrusion 14a that is positioned central to, and that extends outward from a notch 14b in the respective wall. In the preferred embodiment, six or more upper bumper connectors can be provided with one connector located at each corner of the front housing, and one connector centrally located along each of the sidewalls 11e and 11f. Although described with regard to a specific shape and size, any number of these or other types of connectors capable of removably engaging the below described bumpers may also be provided.

As described herein, the front housing 11 may be constructed from any number of different impact absorbing and/or impact deflecting materials and may be semi-rigid, malleable and/or have resilient qualities. Several nonlimiting examples include, but are not limited to silicone, various plastics, and/or composite materials, for example.

In the preferred embodiment, the front housing will be constructed from a semi-rigid ABS plastic that is specifically designed to bend/flex a maximum of between about 1% and 5% along its major axis when impacted by a foreign object before stiffening and ultimately returning to its original shape (e.g., the shape it was before being impacted). Of course, other embodiments are contemplated wherein a different material such as various plastics or composite materials, for example are utilized as well as different flexion amounts are contemplated.

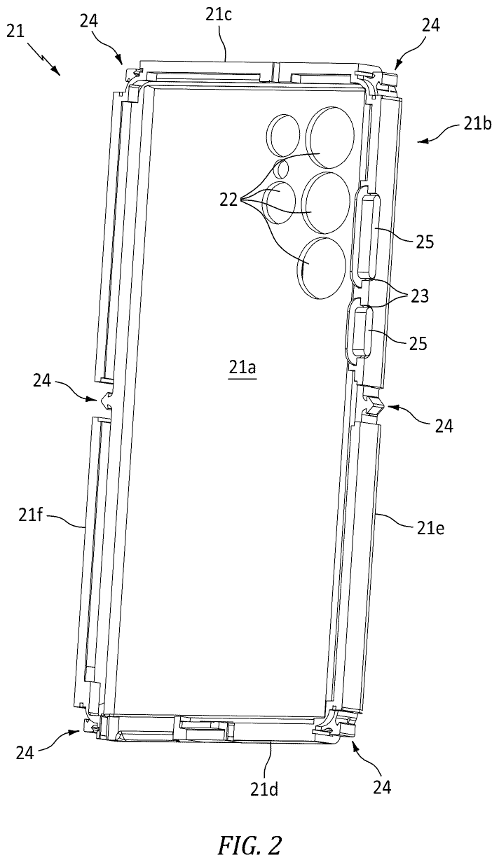

As shown at FIG. 2, the rear housing 21 of the device 10 of the present embodiment can also include a generally rectangular-shaped member having a front surface 21a, a back surface 21b, a top wall 21c, a bottom wall 21d, and a pair of side walls 21e and 21f. As shown, each of the walls 21c-21f can extend upward from the front surface 21a to engage the outside edge of the raised walls 11c-11f, respectively, of the front housing 11.

In one embodiment, one or more openings 22 can be provided along the rear housing. Each of the opening(s) including a shape, size and location that is complementary to a shape, size and location of a camera lens, sensors, LED, microphone and/or speakers of the smartphone to which the case is designed to engage. Additionally, a plurality of openings and/or notches 23 can be provided along the walls 21c-21f of the rear housing. Each of these notches having a shape, size and location that is complementary to the notch or notches on the respective wall 11c-11d of the front housing.

In one embodiment, a plurality of lower bumper connectors 24 can be positioned along each of the walls 21c-21f. Each of the lower bumper connectors 24 can be substantially identical to the upper bumper connectors 14 described above and can be positioned along the lower body walls at locations complementary to those on the front body walls 11c-11f.

In one embodiment, one or more resilient and malleable button inserts 25 can be positioned within one or more of the notches 23 at locations where push buttons are located along the side(s) of the smartphone 1. The button inserts functioning to receive deflective force from a user to access a button or other user interface component of the smartphone. The notches 23 covering the lower half of each of the button inserts, and the notches 13 covering the upper half of each of the button inserts when the case is assembled, so as to fully encompass the outer periphery of the button inserts when the case is in use.

In the preferred embodiment, the rear housing will be constructed from the same semi-rigid and resilient material as the front housing, so as to be designed to flex a maximum of between about 1% and 5% along its major axis when impacted before returning to its original shape. Of course, other embodiments are contemplated wherein a different material, different air gap spacing and/or different flexion amounts are contemplated.

As such, the rear housing may alternatively be constructed from any number of different impact absorbing and/or impact deflecting materials relative to the front housing, and may be rigid, malleable, and/or resilient in nature. Several nonlimiting examples include, but are not limited to silicone, various plastics, and/or composite materials, for example.

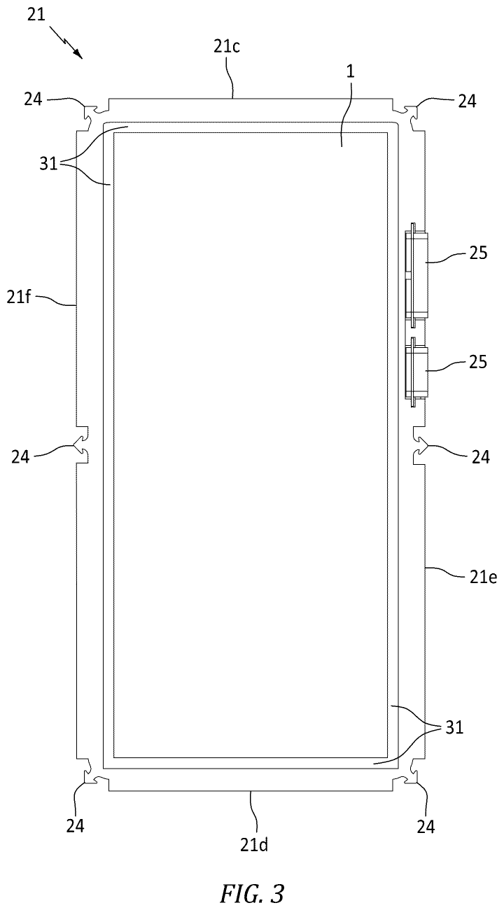

As shown best at FIG. 3, a smartphone 1 can be positioned into the rear housing such that the back surface of the smartphone is resting on the front surface of the housing 21, and each of the walls 21c-21f are located adjacent to the sides of the smartphone. As shown, the rear housing 21 will include a shape that is complementary to the shape of the smartphone 1, but will be sized slightly larger so as to provide a continuous separation or air gap 31 between the inside surface of the walls 21c-21f and the outer edges of the smartphone device 1.

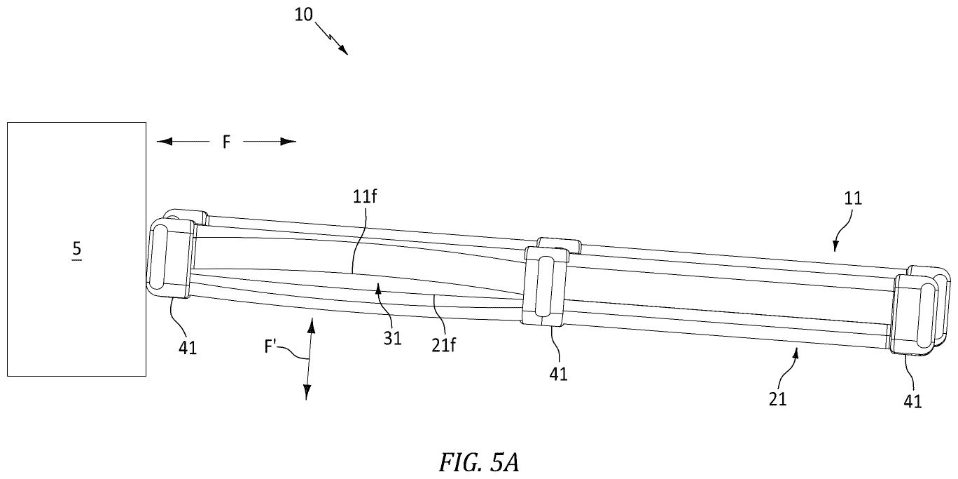

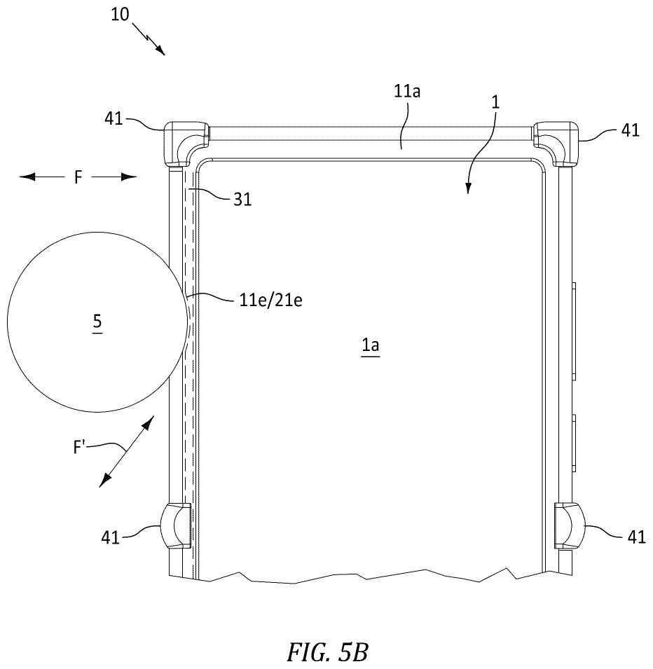

In the preferred embodiment, the rear housing 21 will be specifically sized to provide an air gap of between about.1 mm to 3 mm between the sides of the rear housing and the sides of the smartphone 1 or other electronic device. Such a feature is critical for permitting the case body to bend/flex upon being impacted without transferring the impactive forces onto the device 1 as is shown below at FIG. 5B.

As shown at FIG. 4, the front housing 11 can be positioned over the smartphone 1 and rear housing 21 and lowered until the outside surface of the front housing walls are aligned with and positioned against the inside surface of the rear housing walls. At this time, the top edges of the smartphone will rest against the lip formed by the back surface of the front housing, and the screen la of the smartphone will be accessible via the central opening 12 of the front housing.

When so positioned, the top surface 11a of the front housing 11 will be positioned above the top surface of the smartphone 1, the back surface of the rear housing 21 will be positioned below the bottom surface of the smartphone, and the side walls of both the front housing and the rear housing will be positioned around each of the sidewalls of the smartphone.

Additionally, when the front and rear housings are so aligned, each of the notches 13 and 23 will be aligned to engage the button inserts 25 as described above, and each of the upper bumper connectors 14 will be positioned above and adjacent to a lower bumper connector 24.

In one embodiment, a plurality of removable bumpers 41 can be provided. Each of the bumpers can include any number of different shapes and sizes and can include an opening 41a along a back surface into which the arrow shaped protrusions of the aligned upper and lower bumper receivers 14 and 24 may be secured. Each of the bumpers can function to secure the case in the closed position, and to provide impact deflection and impact force absorption to the case and will preferably be constructed from a solid piece of resilient and elastomeric material such as rubber, latex or silicone, for example, capable of compressing to absorb impactive forces with foreign objects.

As described herein, the bumpers can include any number of different shapes and sizes. In some embodiments, the bumpers may include different colors and/or fanciful designs such as footballs, soccer balls, letters of the alphabet or other such shapes, so as to allow users to customize their device 10 with different bumpers that are tailored to their specific likes and interests. In either instance, the bumpers will be manufactured to include a height that extends above the top surface of the front housing 11, below the bottom surface of the rear housing 21, and outward from the sidewalls of the front and rear housings, respectively to act as a shock absorber when the case is dropped or otherwise impacted by a foreign object.

FIGS. 5A and 5B illustrate one embodiment of the device 10 in operation. As noted above, when no stress is on the device, the side walls of the front housing and rear housings are straight and aligned parallel to each other at positions adjacent to the side walls of the smartphone 1, with the air gap being located between the walls of the case and the walls of the smartphone.

However, when the case is dropped or otherwise makes contact with a foreign object, the internal air gap between the smartphone and the case housings, along with the resilient shape memory of case housings allow the side walls of the front and rear housings to be able to independently flex so as to absorb the impactive force via the deflection in the housing body material. More specifically, the front housing 11 and rear housing 21 can each independently bend, flex or otherwise move into and along the air gap in each of a vertical direction—e.g., towards or away from the top and bottom surfaces of the front and rear housings—as shown at FIG. 5A, and a horizontal direction—e.g., towards or away from the smartphone 1) as shown at FIG. 5B. Such a feature critically and advantageously prevents the impactive forces from passing though the housings onto the smartphone, and instead utilizes the space of the air gap to allow the forces to be completely absorbed via the flexion of the front and/or rear housings.

FIG. 5A illustrates one example of this ability wherein the case 10 and phone are impacted by a foreign object 5 along the top walls of the case. As shown, the impactive force F causes the side walls 11f and 21f to bend in a direction F′ that is perpendicular to the impactive force. Because the air gap is positioned within the case, and results in a separation distance with the smartphone, the deformation of the case body does not impact the smartphone, and the impactive force is not imparted onto the device.

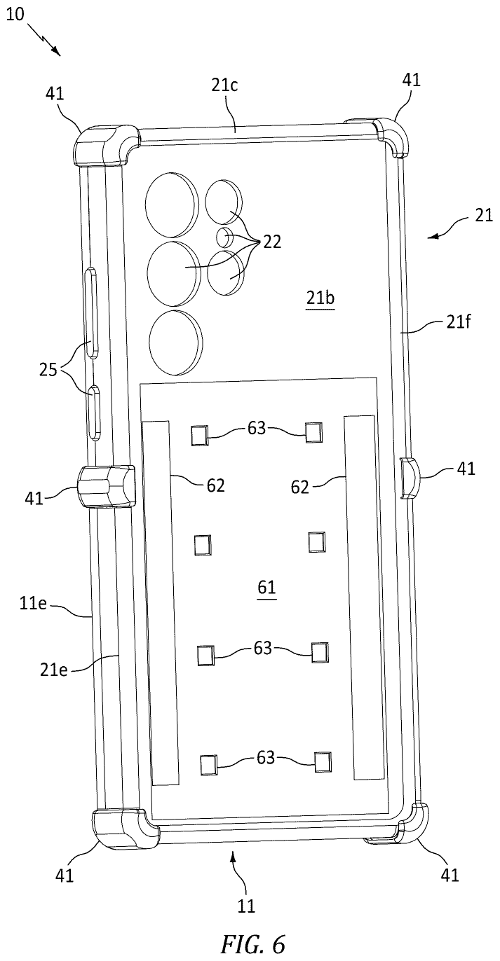

FIG. 6 illustrates one embodiment of the inventive case 10 that further includes a recession 61 along the back surface 21b of the rear housing 21. As shown, the recession can include a pair of elongated metallic strips 62 and a plurality of alignment divots 63 for receiving and engaging a module that can communicate or not with the electronic device in a wired or wireless capacity, so as to allow the device 10 to receive and engage any number of removable modules having any number of functional components as described in copending U.S. patent application Ser. No. 18/507,698, the contents of which are incorporated herein by reference. In this regard, the modules can be pressure fit onto the case and/or magnetically attachable.

As to a further description of the manner and use of the present invention, the same should be apparent from the above description. Accordingly, no further discussion relating to the manner of usage and operation will be provided.

As described herein, one or more elements of the device 10 can be secured together utilizing any number of known attachment means. Moreover, although the above embodiments have been described as including separate individual elements, the inventive concepts disclosed herein are not so limiting. To this end, one of skill in the art will recognize that one or more individually identified elements may be formed together as one or more continuous elements, either through manufacturing processes, such as welding, casting, or molding, or through the use of a singular piece of material milled or machined with the aforementioned components forming identifiable sections thereof.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Likewise, the term “consisting” shall be used to describe only those components identified. In each instance where a device comprises certain elements, it will inherently consist of each of those identified elements as well.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A protective case, comprising:
a front housing having a top surface, a back surface, a central opening, and a plurality of side walls that extend perpendicularly from the back surface;
a rear housing having a top surface, a back surface, and a plurality of side walls that extend perpendicularly from the top surface; and
a plurality of bumpers that are removably secured onto each of the front housing and the rear housing,
wherein the front housing is configured to receive and engage a front surface of a portable electronic device and to position a screen of the portable electronic device within the central opening,
wherein the rear housing is configured to receive and engage a bottom surface of the portable electronic device, and
wherein the plurality of bumpers are configured to secure the front housing and the rear housing onto the portable electronic device.

2. The case of claim 1, wherein each of the plurality of bumpers are removably secured onto each of the front housing and the rear housing.

3. The case of claim 1, wherein each of the plurality of bumpers are constructed from a solid piece of resilient and elastomeric material.

4. The case of claim 2, further comprising:
a plurality of upper bumper connectors that are positioned along the plurality of side walls of the front housing.

5. The case of claim 4, further comprising:
a plurality of lower bumper connectors that are positioned along the plurality of side walls of the rear housing.

6. The case of claim 5, wherein each of the plurality of lower bumper connectors and the plurality of upper bumper connectors include complementary shapes and sizes.

7. The case of claim 5, wherein each of the plurality of lower bumper connectors is positioned adjacent to one of the plurality of upper bumper connectors when the front housing and the rear housing are in a connected orientation.

8. The case of claim 7, wherein each of the plurality of removable bumpers is configured to engage each of an adjacent upper bumper connector and a lower bumper connector.

9. The case of claim 1, wherein each of the front housing and the rear housing are configured to flex upon being impacted with a foreign object.

10. The case of claim 1, further comprising:
at least one interface notch that is positioned along at least one of the plurality of side walls of the rear housing,

11. The case of claim 1, further comprising:
at least one interface notch that is positioned along at least one of the plurality of side walls of the upper housing.

12. The case of claim 11, wherein each of the at least one interface notch on the front housing is aligned with each of the at least one interface notch on the rear housing when the front housing and the rear housing are in a connected orientation.

13. The case of claim 12, wherein each of the at least one aligned interface notches are positioned adjacent to a user interface component of the portable electronic device positioned within the front and rear housings.
